(19) United States
(12) Patent Application Publication
(10) Pub. No.: US 2015/0100470 A1
(43) Pub. Date: Apr. 9, 2015

(54) SYSTEMS AND METHODS FOR PARSING UNKNOWN CODES OBTAINED FROM A CUSTOMIZABLE SPREADSHEET APPLICATION INTERFACE

(71) Applicants: Adrian G. Breef, Chicago, IL (US); Brad Teaver, Roswell, GA (US)

(72) Inventors: Adrian G. Breef, Chicago, IL (US); Brad Teaver, Roswell, GA (US)

(21) Appl. No.: 14/571,552

(22) Filed: Dec. 16, 2014

Related U.S. Application Data
(63) Continuation of application No. 13/762,509, filed on Feb. 8, 2013.

(51) Int. Cl. G06Q 40/02; G06F 9/54

(52) U.S. Cl. CPC G06Q 40/02; G06F 9/54
USPC 705/35

(57) ABSTRACT

An improvement in a customizable spreadsheet application is provided. The improvement preferably provides an interface between the customizable spreadsheet application and a third party financial institution application. The improvement preferably includes an application programming interface (“API”) that is configured to receive a Bank Administration Institute, version 2 (“BAI2”) file. The improvement is further configured to query whether the identity of the third party financial institution associated with the financial institution application is recognized by the API. If the identity of the third party financial institution is recognized by the API, then the improvement is further configured to query whether any customized codes associated with third party financial institution exist in the BAI2 file. If any customized codes associated with the third party financial institution exist in the BAI2 file, then the improvement preferably determines whether the customized codes have already been associated, preferably by the API, with interpretations.

### FIELD OF TECHNOLOGY

This invention relates to systems and methods for providing a customizable spreadsheet interface.

### BACKGROUND OF THE DISCLOSURE

Some of the problems addressed by a system according to the invention may include the following.

First, entities with bank accounts at different banks have to gather banking data and consolidate it for cash reporting purposes. Furthermore, data retrieved from bank websites may be stored in a proprietary bank format and require re-keying or other manipulation. In addition, since different users within a single entity may have different levels of data access, multiple data retrievals from bank systems may often be required to obtain different data sets. Also, many bank applications maintain limited amounts of transaction history for viewing and, in order to utilize historical data, additional, data-gathering steps must be taken. Moreover, if the person responsible for daily data gathering is unavailable, the data may be missed for that day. In some banking applications, when investigating or auditing a transaction, a user often has to access remote systems to obtain detailed transaction information. Finally, users often spend time trying to figure out what transactions have been missed for the purposes of calculating the prior day cash position. It would be advantageous to provide a customized spreadsheet application that can receive and consolidate banking data and that addresses the aforementioned problems.

### SUMMARY OF THE DISCLOSURE

An improvement in a customizable spreadsheet application is provided. The improvement preferably provides an interface between a customizable spreadsheet application and a third party financial institution application. The improvement preferably includes an application programming interface (“API”) that is configured to receive a Bank Administration Institute, version 2 (“BAI2”) files. The improvement is further configured to query whether the identity of the third party financial institution associated with the financial institution application is recognized by the API. If the identity of the third party financial institution is recognized by the API, then the improvement is further configured to query whether any customized codes associated with third party financial institution exist in the BAI2 file. If any customized codes associated with the third party financial institution exist in the BAI2 file, then the improvement preferably determines whether the customized codes have already been associated, preferably by the API, with interpretations. Otherwise, the user may provide customized code interpretations.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows apparatus that may be used in accordance with the systems and methods of the invention;

FIG. 2 shows a flow diagram of a portion of a process that may be used in accordance with the systems and methods of the invention;

FIG. 3 shows an exemplary dashboard that may be used in some embodiments of the invention;

FIG. 4 shows an exemplary dialogue box for use with systems and methods according to the invention;

FIG. 5 shows a list of exemplary currency exchange rates for use in systems and methods according to the invention;

FIG. 6 another exemplary dialogue box for use with systems and methods according to the invention;

FIG. 7 shows another aspect of the exemplary dialogue box shown in FIG. 6;

FIG. 8 shows a portion of the exemplary dialogue box shown in FIG. 6;

FIG. 9 shows a portion of the exemplary dialogue box shown in FIG. 6;

FIG. 10 shows a portion of the dialogue box shown in FIG. 6;

FIG. 11 shows a portion of the dialogue box shown in FIG. 6;

FIG. 12 shows a cash availability screen according to the invention;

FIG. 13 shows a spreadsheet workbook according to the invention;

FIG. 14 an exemplary XML schema that may be used with systems and methods according to the invention;

FIG. 15 shows an exemplary BAI2 file for use with systems and methods of the invention; and

FIG. 16 shows an exemplary flow chart according to the invention.

### DETAILED DESCRIPTION OF THE DISCLOSURE

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

As will be appreciated by one of skill in the art upon reading the following disclosure, various aspects described herein may be embodied as a method, a data processing system, or a computer program product. Accordingly, those aspects may take the form of an entirely hardware embodiment, an entirely software embodiment or an embodiment combining software and hardware aspects. Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, flash memory devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

Some of the aforementioned problems described above may be addressed by a system according to the invention in the manner that follows.

As mentioned above, entities with bank accounts at different banks have to gather the data and consolidate it for cash reporting purposes. Multi-bank access capabilities, according to the invention, offer the flexibility to access data from almost any financial service provider and consolidate the data for use by a user.

Second, conventional spreadsheets are not protected from alteration. However, some data fields as used in systems according to the invention are preferably protected, preventing (encrypted) figures from being altered or misrepresented. This ensures data integrity and helps support Sarbanes-Oxley controls.

Third, for data extracted from bank websites, a system according to the invention preferably provides sufficient flexibility in order to create custom-built spreadsheets to fit users' respective reporting needs.

Fourth, in order to address the fact that multiple data retrievals from bank systems may often be required to obtain different data sets, enhanced security features according to the invention allow for multiple user profiles, each of which preferably defines distinct information access.

Fifth, in response to the maintenance of limited amounts of transaction history for viewing, systems according to the invention may store historical account data that can be imported and used to populate spreadsheets for a predetermined period of time. Once imported, the data can even be available, in some embodiments, until the user elects to delete it.

Sixth, systems according to the invention can download data either manually or automatically via the use of a scheduler.

Seventh, when investigating or auditing a transaction, a user often has to refer to other bank systems to obtain detailed transaction information. A system according to the invention may preferably store data locally in both summary and details form for future analysis thus reducing redundant download fees.

Eighth, users often spend time trying to figure out which transactions they missed in their prior day cash position. In yet another aspect of the invention, a reconciliation feature according to the invention preferably allows users to compare forecasts from the day before with what was actually posted during the night following the previous day.

A cash positioning and reporting tool according to the invention may be implemented using a spreadsheet application and Extensible Markup Language (“XML”) technology.

A cash positioning and reporting tool according to the invention may gather data from bank websites or other data sources and populate that information into suitable spreadsheet applications. Such a system, according to the invention, can save time and improve accuracy over any conventional method of data management and data entry.

With respect to entering data into a workstation dedicated to receiving reports from an external system, embodiments may reduce training compared to more complex systems.

In some embodiments, an XML-based interface which enables output in a spreadsheet format may be provided. Such an interface may preferably support for receipt and parsing of data files for use with a CashPro Accelerate™ Application (hereinafter “CPA”), a treasury management application manufactured by the assignee, or other suitable treasury management software application. Such an interface may use received and parsed information to preferably populate a spreadsheet for display to a CPA user.

Some embodiments may be configured to receive raw Bank Administration Institute, Version 2 (“BAI2”) files, either through manual entry or through an API, and parse the raw BAI2 files for entry into a spreadsheet supported by the interface. While the present disclosure refers to BAI2 files, it should be noted that the systems and methods of the invention may be adapted for, and the scope of the invention does indeed cover, use with X9 BTRS (Balance and Transaction Reporting Standard) files or any other suitable file format(s) that may be suggested for use, or presented for implementation, by the BAI organization. The X9 BTRS (Balance and Transaction Reporting Standard) are described in greater detail in the American National Standard for Financial Services ANSI X9.121-2012 Balance and Transaction Reporting Standard and the “BAI Reporting Reborn as BTRS”, The Journey to Create a Global Reporting Standard, which are both hereby incorporated by reference herein in their respective entireties.

Accordingly, a user can enter raw BAI2 files, or any other suitable files, and an interface according to some embodiments may then convert the raw BAI2 files for use in a CPA application, or other suitable spreadsheet application, file. The file (which file may be input or output) may also be encrypted.

In certain embodiments, green-shaded cells in the spreadsheet may be used for internally-generated CPA data.

Yellow-shaded cells may be used for user entered data. Data may be entered either through manual input or obtained through an application programming interface (“API”).

Grey-shaded cells may represent formulas.

In certain embodiments, if a user selects, and clicks, a cell, the cell may provide an additional list that has been heretofore truncated.

Such features may preferably be implemented as an add-on application embedded in Microsoft Excel™, manufactured by Microsoft Corporation of Redmond, Wash. or by some other suitable spreadsheet program.

A “get” command, as supported by certain embodiments of the invention, may preferably obtain the BAI2 files and/or data from an online system via Secure Sockets Layer (“SSL”) encryption, or other suitable encryption, and import BAI2 to an application known as CPA, or other suitable application. CPA may translate the BAI2 files, according to the invention, and/or data to an XML schema for use in populating a spreadsheet workbook.

In certain embodiments, each get command may obtain real time BAI data which may include updates of same day data and previous day data. In addition, certain embodiments may provide outstanding issued payments—i.e., checks that are written but have not been cashed.

Certain embodiments may also provide foreign currency translated to a “home” currency. Such a home currency may preferably be user-designated and/or system-set. In addition, the currency rates associated with such a home currency may be based on a daily rate, a weekly-set rate, a monthly-set rate, an annual rate or any other suitably set rate.

Certain additional aspects of the invention relate to providing multiple fixed sheets. Other aspects of cash positions, such as end dates, weekly totals, and/or monthly totals of cash positions, may also be supported by systems and methods according to the invention. Furthermore, certain embodiments may be used to obtain historical data with a “retrieve” button and/or or other selectable field. Such retrieval may preferably retrieve information beyond the same day and previous day information.

Moreover, certain embodiments may maintain historical data so long as it was retrieved every day. In certain embodiments, a scheduler may periodically retrieve information via a script and/or daemon.

Certain BAI2 files may be imported to a remotely maintained spreadsheet application prior to passing the data into CPA.

One problem associated with such functionality—input of BAI2 files into the CPA application according to the invention—is that some BAI2 codes are customized codes. The customized, “non-standard,” codes are made available for further user-defined, or system-set, definition.

Certain embodiments may use header records to parse files and/or query the user about the day's/previous day's transactions, about the names of accounts and/or about custom code meanings.

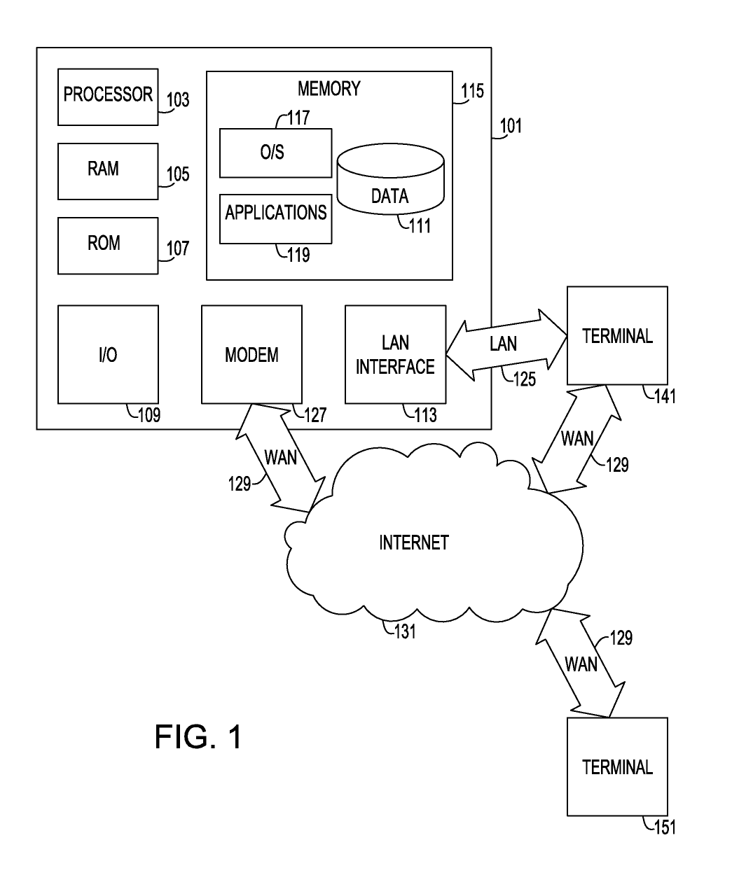

Then the responses to the queries may be stored for future use, in order to maintain translation information, with preferably incremental prompting for new information as needed. The translation information may be maintained to interpret the customized codes when they appear in the future. The following portion of the specification corresponding to FIGS. 1-16 details operation of applications according to the invention. The translation information may preferably be included with the intake of a new account.

FIG. 1 is a block diagram that illustrates a generic computing device 101 (alternately referred to herein as a “server”) that may be used according to an illustrative embodiment of the invention. The computer server 101 may have a processor 103 for controlling overall operation of the server and its associated components, including RAM 105, ROM 107, input/output module 109, and memory 115.

Input/output (“I/O”) module 109 may include a microphone, keypad, touch screen, and/or stylus through which a user of server 101 may provide input, and may also include one or more of a speaker for providing audio output and a video display device for providing textual, audiovisual and/or graphical output. Software may be stored within memory 115 and/or storage to provide instructions to processor 103 for enabling server 101 to perform various functions. For example, memory 115 may store software used by server 101, such as an operating system 117, application programs 119, and an associated database 111. Alternately, some or all of server 101 computer executable instructions may be embodied in hardware or firmware (not shown). As described in detail below, database 111 may provide storage for information input into the spreadsheet application and/or the CPA application.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 113. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages via the World Wide Web from a cloud-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

A terminal such as 141 or 151 may be used by a user of the systems and methods of the invention to access and input information into the spreadsheet application and/or the CPA application. Information input into the spreadsheet application and/or the CPA application may be stored in memory 115. The input information may be processed by an application such as one of applications 119.

A system according to the invention may provide BAI2 files for viewing and manipulation in the form of a spreadsheet workbook. The system may be used to receive and/or generate entry data and transmit such data to a cash positioning and reporting system such as CashPro Online (hereinafter, “CP”), manufactured by the assignee, having a place of business at Charlotte, N.C.

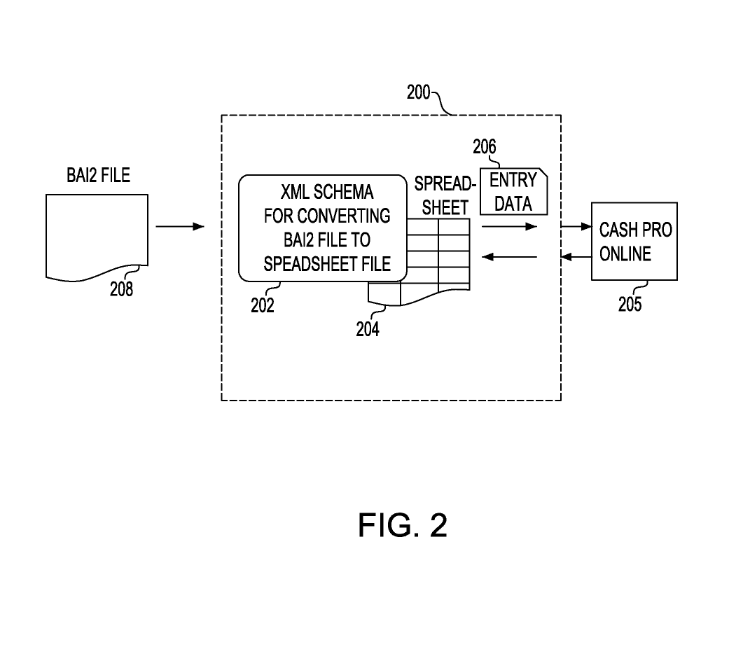

In certain embodiments, the system may receive information from other financial institutions. In certain embodiments, an application such as CPA, which may be separate from, or form a portion of, the system, may receive information from other financial institutions. Such transfers of information are described below in the portion of the specification corresponding to FIG. 2.

FIG. 2 shows CPA system 200, XML schema interface 202, spreadsheet 204 and entry data 206. Entry data 206 may be received from and/or forwarded for entry into a cash positioning and reporting system such as CP 205. All of these components may be included within CPA 200.

CPA 200, according to the invention, may preferably be configured to receive BAI2 file 208. BAI2 file 208 may originate, for example, at one or more remote—i.e., third party—financial institutions. BAI2 file 208 may preferably include some or all of its information in a BAI2 format.

BAI2 file 208 may include customized fields or other financial institution unique information. XML Schema 202 may preferably be configured to receive BAI2 file 208 and convert, homogenize and/or otherwise adapt the data for display, for further management and/or transmission of the data to a CP application.

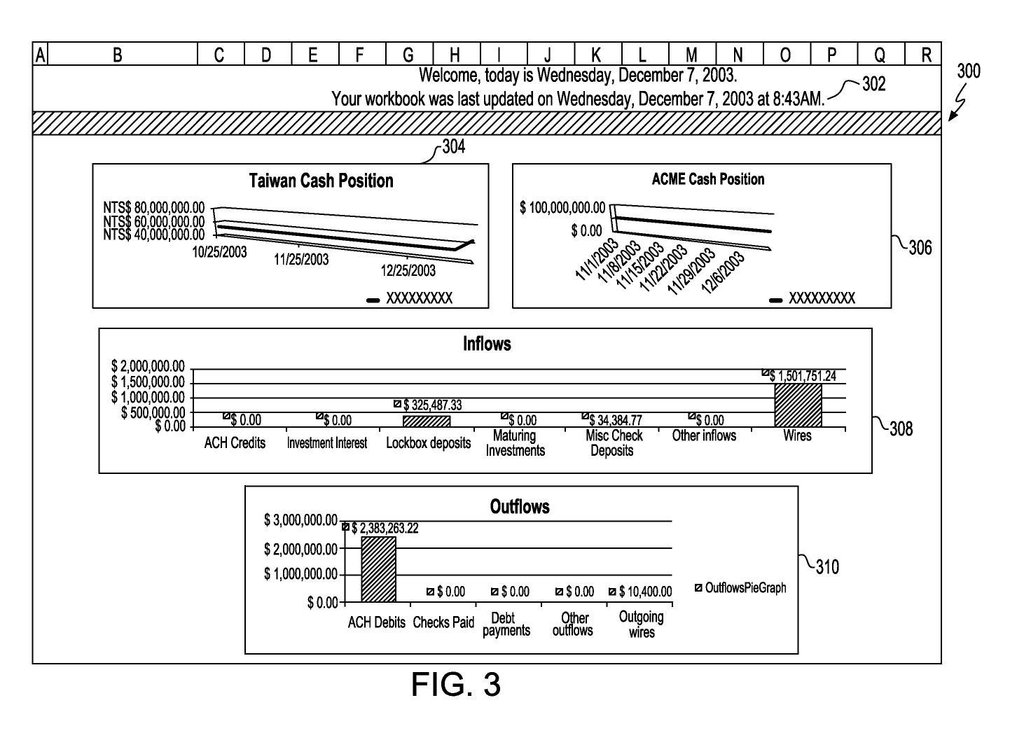

FIG. 3 shows an exemplary dashboard 300 that may be used in some embodiments of the invention. The exemplary dashboard may include default settings that may either be system-set and/or user-defined.

Dashboard 300 may include welcome message 302. Message 302 may include some indication of the freshness of the data, as well as an indication of the last time the data was refreshed.

Dashboard 300 may further include various cash positions such as a Taiwan cash position 304 and/or an entity cash position 306. Dashboard 300 may also include inflows 308. Inflows 308 may include inflows from such sources as ACH credits, investment interest, lockbox deposits, maturing investments, miscellaneous check deposits, other inflows and/or wires. Dashboard 300 may also include outflows 310 such as outflows from ACH debits, checks paid, debt payments, other outflows, outgoing wires or any other suitable outflows.

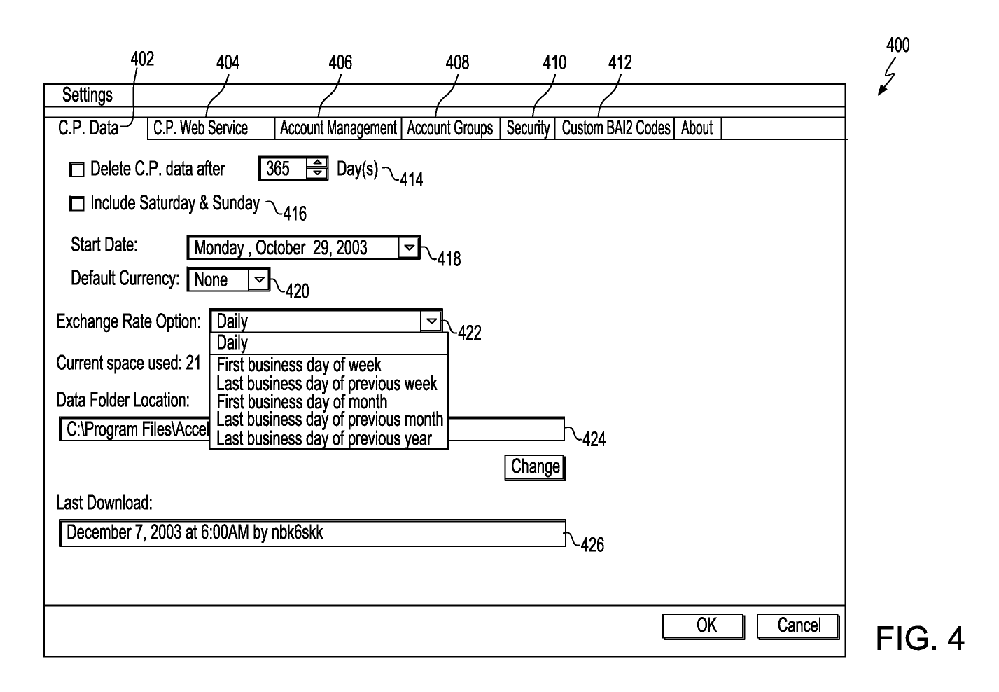

FIG. 4 shows an exemplary dialogue box 400 for use with systems and methods according to the invention. Tab 402 is associated with a data screen according to the invention. The other tabs may include a web service tab 404, an account management tab 406, a security tab 410 and a custom codes tab 412. For the purposes of this application, dialogue boxes associated with tabs 402 and 412 are described in detail in tab 408.

Delete setting 414 may preferably be used to set the amount of storage time for imported CPA data. Weekend setting 416 may preferably be used to set whether the system retrieves Saturday and/or Sunday information. Start date 418 may be used to determine the start date for information retrieval.

Default currency selector 420 may implement a home currency setting. Such a setting may be either system-set and/or user-defined. In addition to selecting which currency is the home currency to be used for system presentations and/or other system functions, other currency options may also be available. For example, an exchange rate option 422 may be available in a system-set and/or user-defined circumstance. Exchange rate option 422 may be set to use the currency exchange rate as it was on the first business day of the week, the last business day of the previous week, the first business day of the month, the last business day of a previous month, the last business day of a previous year or any other suitable date.

Finally, data folder location 424 may show where the data is located and last download 426 may indicate when the last download occurred.

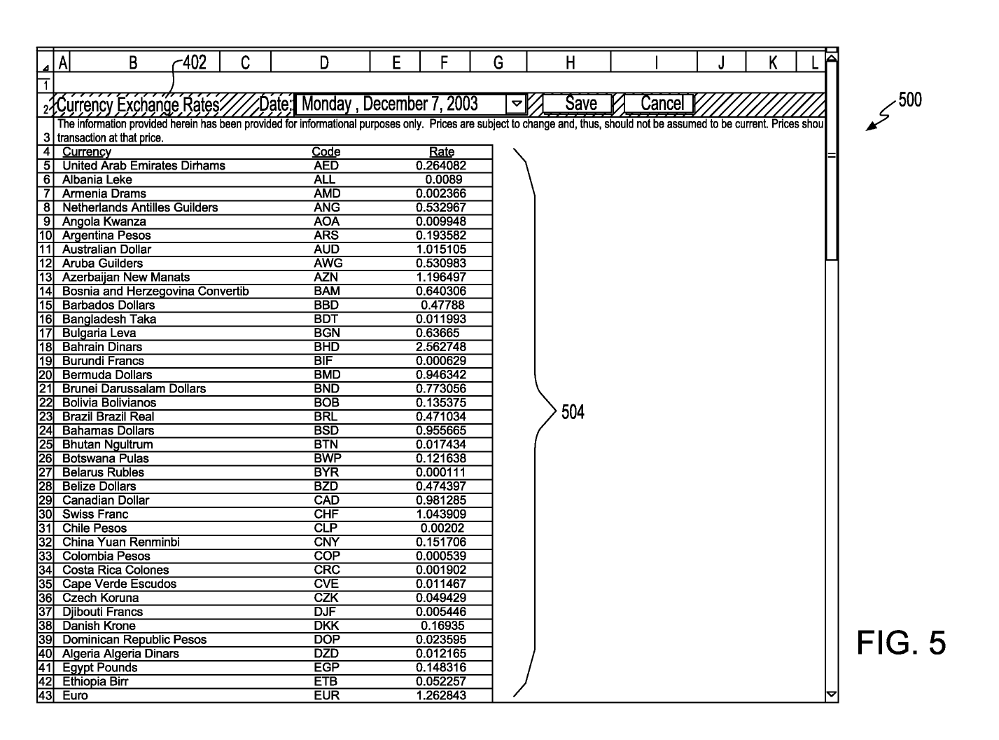

FIG. 5 shows a list of currency exchange rates 402 for use in systems and methods according to the invention. In certain embodiments of the invention, the currency exchange rates may include information regarding the relative value of each currency with respect to the home currency. In certain embodiments of the invention, the rates may coincide with the selection made in exchange rate option 420 shown in FIG. 4.

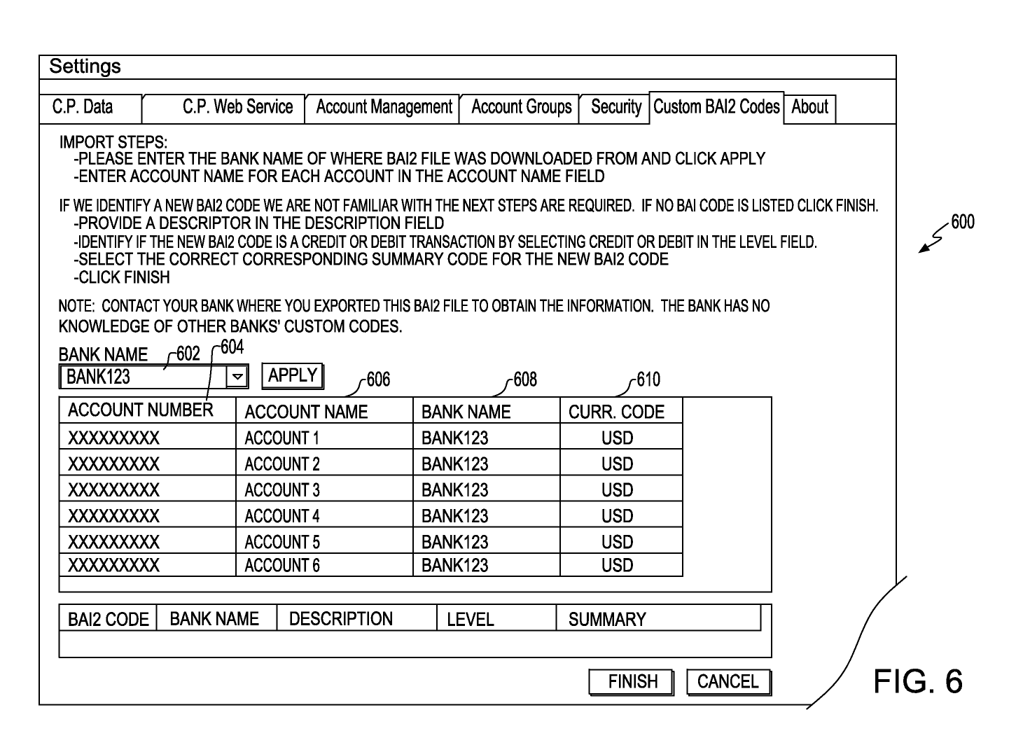

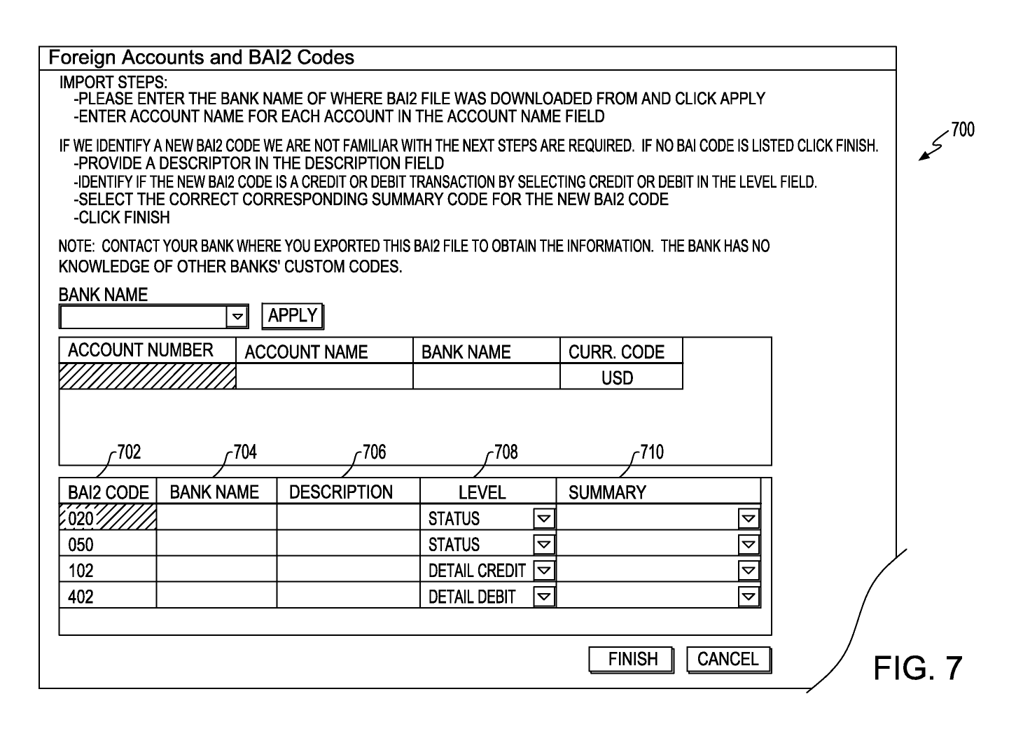

FIGS. 6 and 7 show dialogue boxes 600 and 700 (linked to the Custom BAI2 tab 412 shown in FIG. 4) that relates to foreign accounts and BAI2 codes. Dialogue box 600 preferably supports importing information from one or more financial institutions. Import steps may include entering the bank name associated with the BAI2 file download; and then clicking apply.

FIG. 6 shows that an exemplary dialogue box including a bank name may be selected from a drop down menu 602. The bank name may be associated with a bank that provides banking services to the user of the application.

Account number 604 may be associated with an account at the bank in menu 602. Dialogue box 500 may show that the account includes a unique identifier 606. Dialogue box 600 may also show the association with the bank. Furthermore, a currency code 610 may also be shown. Currency code 610 preferably identifies the home currency associated with the account.

FIG. 7 shows certain embodiments that are configured to implement known BAI2 codes. With respect to known BAI2 codes, a user may provide a BAI2 code 702 in a field. BAI2 code 702 may be associated with a bank name 704. Furthermore, dialogue box 700 may include a description of the code (which may be in the form of an alphanumeric code) at 706, as well as the level of the code 708. Code level 708 may include an indication as to whether the code is a credit, debit or a status indicator. Field 710 may summarize the code and include other relevant information.

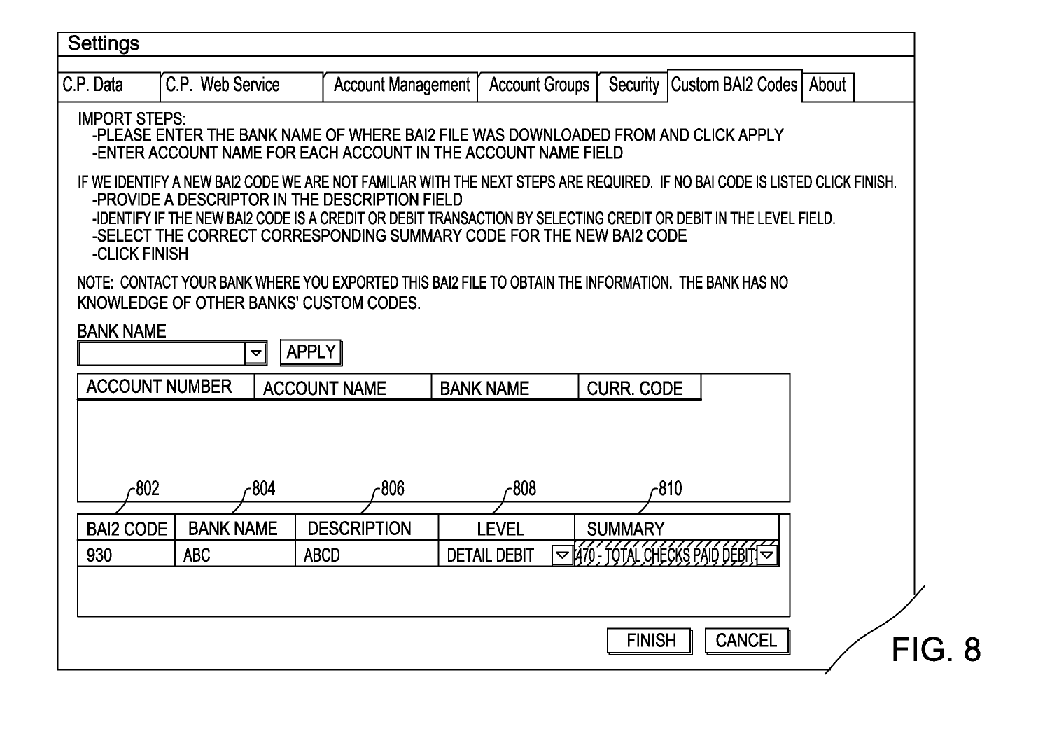

FIG. 8 shows an exemplary custom BAI2 code 802 identified by the number 930. It should be noted that 900 series BAI2 codes are typically reserved for custom BAI2 codes. Bank name 804 is identified by the exemplary character sequence ABC. Exemplary code description 806 describes the code with an exemplary four-character code ABCD. Exemplary level 808 shows that the code represents a detail debit and summary 810 shows that the customer code corresponds to BAI2 code 470, which, in turn refers to total checks paid and represents a debit.

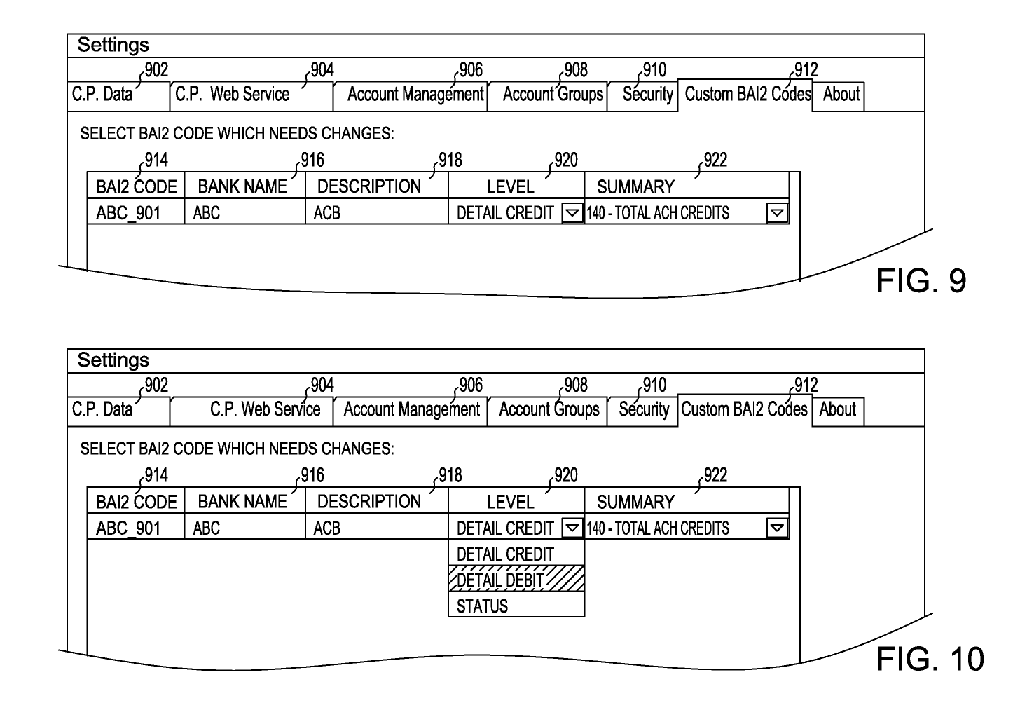

FIG. 9 shows a exemplary selected BAI2 code that requires a change. In the illustrative example shown in FIG. 9, BAI2 code (914) ABC 901, which is associated with ABC bank 916, described by ACB 918, associated with a detail credit 920 and can be summarized (922) by code 140—i.e., total ACH credits—requires a change.

FIG. 10 shows that a possible change that may be applied to ABC 901 may include a change of the level of the code 920 from a detail credit to a detail debit. In response to the application of the level change to the code, the summary 922 and/or the description 918 may change as well.

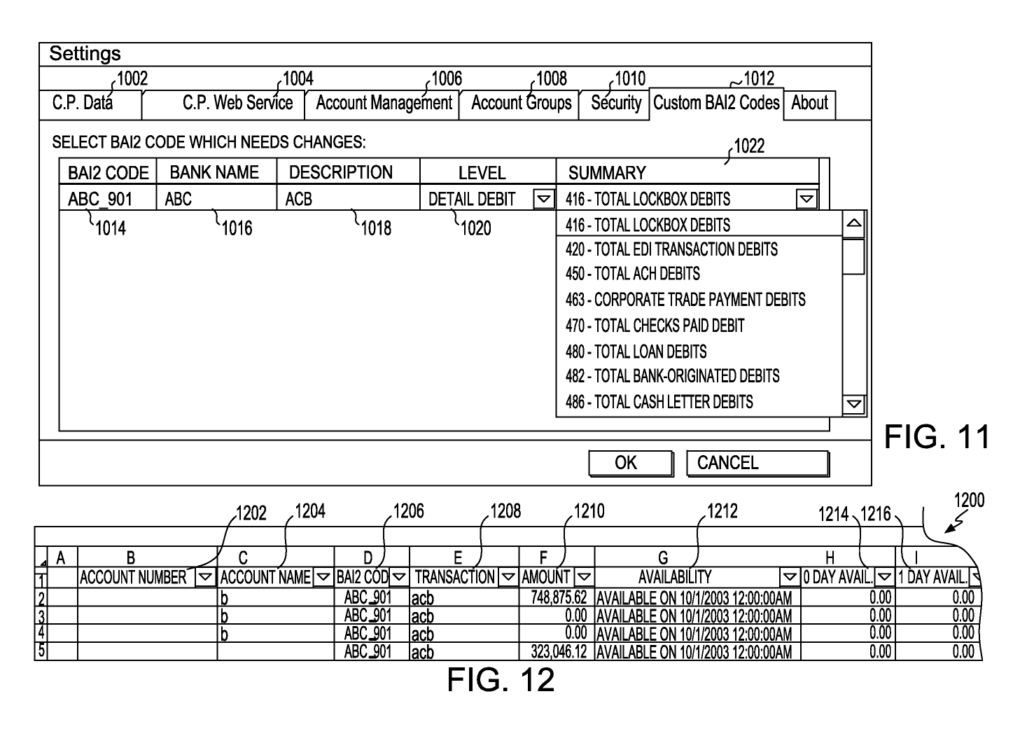

FIG. 11 shows implementing a change of a summary 1122 for a selected BAI2 code. FIG. 11 also shows, together with selected summary 1122, code 1014, name 1016, description 1018, and level 1020, a portion of a list of exemplary BAI2 summary codes.

FIG. 12 shows a cash availability screen 1200. Screen 1200 may preferably show account number 1202, account name 1204, BAI2 code 1206, transaction identifier 1208, amount 1210, availability 1212, 0-day amount availability 1214, and 1-day amount availability 1216.

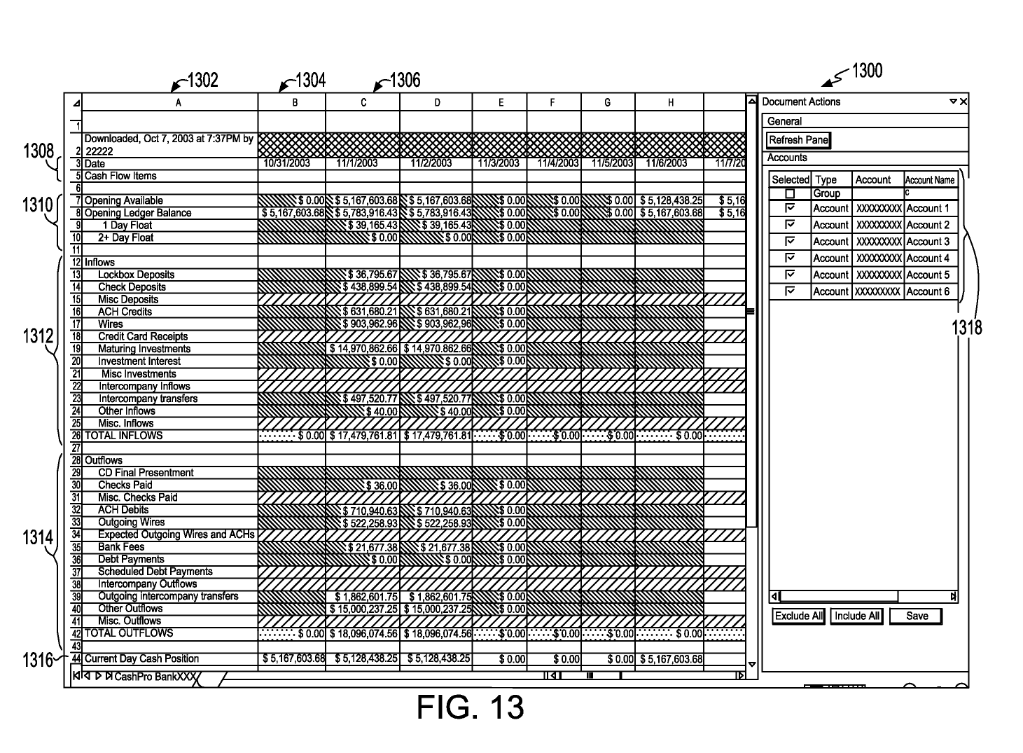

FIG. 13 shows a spreadsheet 1300. Spreadsheet 1300 includes column 1302, 1304, 1306, etc. Column 1302 shows headings for the various rows. Columns 1304, 1306 show the various values extended over a predetermined date range. Rows 1308 include a current date and a cash flow items label.

Rows 1310 relate to an exemplary breakdown of available cash amounts. Rows 1312 include various inflows as well as an inflow total amount. Rows 1314 include various outflows as well as an outflow total amount. Row 1316 shows a current day cash position, in view of the opening balance information, as shown in rows 1310, inflow information 1312 and outflow information 1314.

Panel 1318 allows a user to select which accounts, and associated account information, that the user wants to be included in spreadsheet 1300.

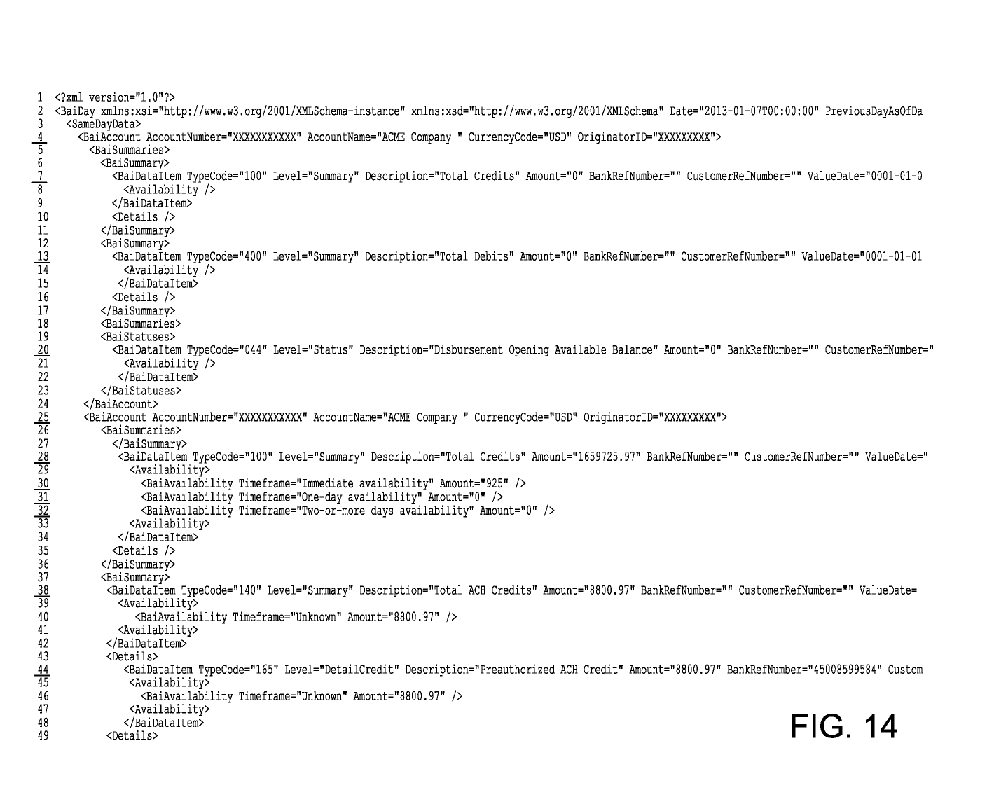

FIG. 14 shows an exemplary XML schema that may be used with systems and methods according to the invention. The title of the schema may be found at line 2. Exemplary account numbers, used for identifying the transactions, may be found at lines 4 and 25. Exemplary BAI2 records may be found at lines 7, 13, 20, 28, 38 and 44. Such records may include information such as type code, level, description, amount, identifiers such as bank reference number and/or customer reference number, value date, currency code, etc. Exemplary lines 30, 31 and 32 include information such as availability. In lines 31-33 the availability relates to the record in line 28. The information included in the record typically depends on the type code of the record.

XML schema may preferably be used to provide an interface between the imported BAI2 files and the CPA application. Specifically, the XML schema make take the imported, raw, BAI2 files and convert them for use, according to the methods provided by the invention, for use in a user-facing CPA application.

The following table illustrates selected records from a BAI2 file exported from CPA and opened in a text editor. Additional information regarding the BAI2 file may be found in the Cash Management Balance Reporting Specifications Version 2 Technical Reference Manual which is hereby incorporated by reference herein in its entirety, said manual which can be obtained from BAI of One North Franklin, Suite 1000, Chicago, Ill.

| Record | General description |
|---|---|
| A | 01,BANKOFAMERICA,USGCIB,041007,1152,1,80,1,2/ |
| | 01 - File header record |
| | BANKOFAMERICA - Sender identification (always |
| | BANKOFAMERICA) |
| | USGCIB - Company ID number |
| | 041007 - File create date (6 spaces) |
| | 1152 - Military format (2400) in the preferred time zone of |
| | the user. U.S. default will be Central time zone and |
| | international default will be GMT (4 spaces). |
| | 1 - File identification number |
| | 80 - Physical record length (always 80) |
| | 1 - Block size (always 1) |
| | 2 - BAI version number |
| | / - End of record |
| B | 49,1987424452,73/ |
| | 49 - Account trailer record |
| | 1987424452 - Algebraic sum of all amounts in record codes |
| | 03, 16, and 88 associated with this account |
| | 73 - Total number of records in the account, including the 03, |
| | 16, 88, and 49 records |
| | / - End of record |
| C | 98,1987424452,1,75/ |
| | 98 - Group trailer record |
| | 1987424452 - Algebraic sum of all account control totals |
| | (record 49) |
| | 1 - Total number of 03 records in the file |
| | 75 - Total number of records in the file, including the 02, 03, |
| | 16, 49, 88, and 98 records |
| | / - End of record |
| D | 02,USGCIB,111000025,1,041004,2359,, / |
| | 02 - Group header record |
| | USGCIB - Company ID number |
| | 111000025 - Originator identification (originator's ABA or |
| | SWIFT ID, depending on the location of the account; 9 |
| | spaces) |
| | 1 - Group status (always 1) |
| | 041004 - As of date (6 spaces) |
| | 2359 - As of time (always “2359”) |
| | Currency Code is null |
| | / - End of record |
| E | 03,808080808080,USD/88,015,11159900,,Z/ |
| | 03 - Account identifier and summary status record |
| | 808080808080 - Account number (normally 10 or 12 spaces) |
| | USD - Currency code (3 spaces) |
| | / - End of record |
| | 88 - Continuation of record |
| | 015 - Summary/Balance BAI code (3 spaces). For |
| | descriptions of BAI codes, refer to Bank Administration |
| | Institute (BAI) Codes for more information. |
| | 11159900 - Dollar amount |
| | Item count null |
| | Z - Float (1 space). Types possible: |
| | —Z = Availability unknown |
| | —0 = Immediate (0) availability |
| | —1 = One-day availability |
| | —2 = Two-or-more day availability |
| | —S = Availability distributed. If S, then the next three fields |
| | are: |
| | 1) Immediate availability |
| | 2) One-day availability |
| | 3) Over one-day availability |
| | —V = Value dated. If V, then the next two fields are: |
| | 1) Value date (YYMMDD) |
| | 2) Value time (always 0000) |
| | —D = Distributed availability. If D, the next field indicates |
| | the number of availability distributions. The next two fields |
| | (and each succeeding pair of fields) indicate the number of |
| | days and the amount available, respectively. Format: |
| | “X,a,$,a,$”. |
| | X = Number of distributions |
| | a = Availability in days (integer) |
| | $ = Available amount |
| | / - End of record |

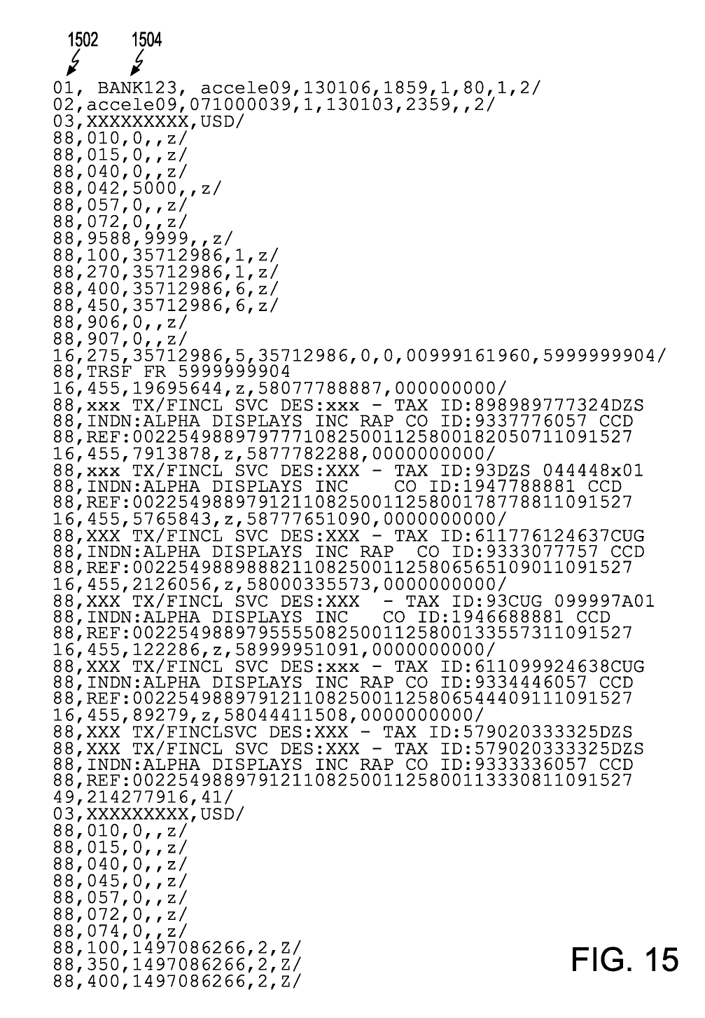

FIG. 15 shows an exemplary BAI2 file. BAI2 file includes various records. Each record has a record code 1502 and a record body 1504.

As described above, FIG. 2 shows that BAI2 file 208 may be received from remote sources such as banks or other financial institutions. For example, a system and method according to the invention may receive BAI2 files 208 from CPA and non-CPA institutions, as described in the technical reference manual. These files may include standard codes such as the 01, 02 and 88, etc. set forth in the table above. These files may also contain customized codes. These codes may be referred to as 900 codes. Alternatively, any of the BAI2 codes could be customized.

When a file is received by a CPA system from a CPA source, the meaning of the customized codes is typically known and the data can be parsed quickly and accurately.

In some embodiments, each non-CPA, third party financial institution may have its own BAI2 file format. As such, the identity of the third party may also be identifiable upon detection of the third party format. Accordingly, when a CPA system receives a BAI2 file, the CPA system may preferably identify the third party from whom the BAI2 file was received. Thereafter, the CPA system can parse the file according to the format associated with the identified third party. The identification of the third party format may be implemented in conjunction with, or separate from, the identification, and interpretation, of the customized codes.

Furthermore, when a file is received from a non-CPA, third party, system, customized codes may be extracted. Thereafter, each customized code is preferably presented to a user for interpretation. Upon completion of interpretation of customized code, the file including the customized, and any files received in the future including the customized code, can be parsed.

In one embodiment, following interpretation of the customized codes, the interpretation of the customized codes may be assigned to the institution from which it was received. Thereafter, any additional files received from the same institution may be parsed accordingly. This may assume that the additional files include no additional custom codes. This may further assumes that each institution maintains a consistent set of interpretations for each of its custom codes. In certain embodiments, when the additional files include additional customized, heretofore uninterpreted, customized codes, the system may present the additional codes to a user for interpretation.

When the system identifies a new BAI2 code with which it is not familiar, additional steps may be implemented.

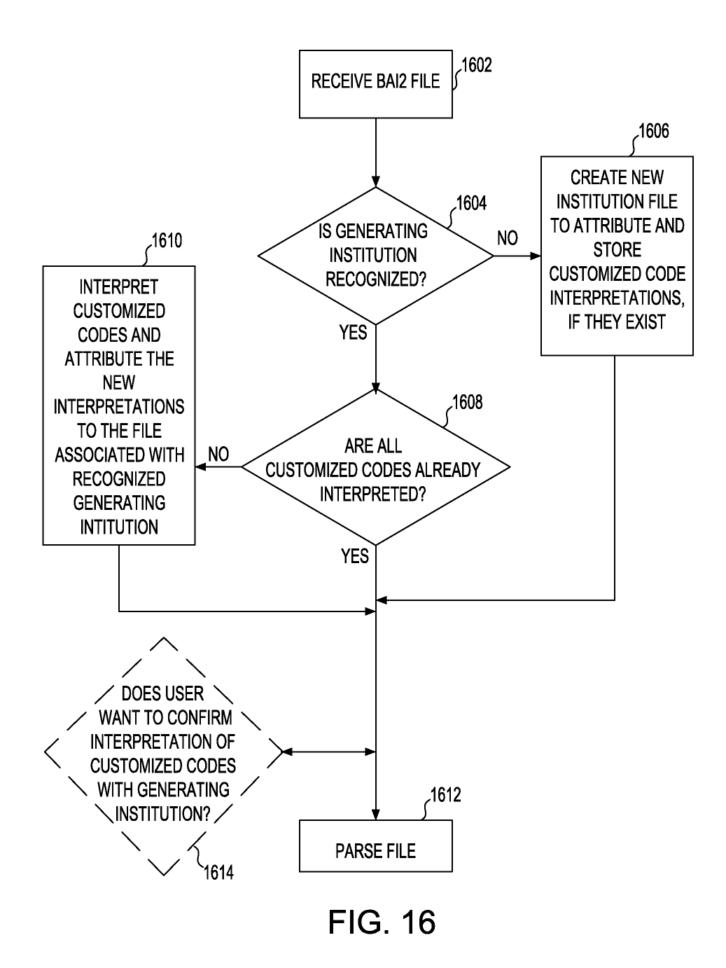

FIG. 16 shows an illustrative flow chart that includes additional steps that may be implemented upon receipt of a BAI2 File 1602. Following receipt of the file at 1602, an application according to the invention may query, at 1604, whether the application recognizes the institution that generated the file. If the application does not recognize the institution that generated the file, then the application may create a new institution file, at 1606, to attribute and store customized code interpretations, is such customized codes exist.

If the application recognizes the institution that generated the file, then the application may determine, at 1608, whether all customized codes in the file have already been interpreted. If all customized codes in the file have not already been interpreted, then, at 1610, the application may interpret customized codes and attribute the new interpretations to the file associated with the recognized file-generating institution. It should be noted that in certain embodiments, interpretation of the codes may include prompting an application user to enter certain information regarding the codes. In certain embodiments, interpretation of the customized codes may be implemented via a learning algorithm and/or any other suitable algorithm for determining the function of the customized codes.

If all the customized codes have already been interpreted, or, in the alternative, following completion of either step 1606 or step 1610, the application may proceed to parse the file at 1612. In certain embodiments of the invention, prior to parsing the file at 1612, the application may query, at step 1614, whether the user wants to confirm interpretation of customized codes with the file-generating institution.

Thus, methods and apparatus for providing a customizable spreadsheet application interface have been provided. Persons skilled in the art will appreciate that the present invention can be practiced in embodiments other than the described embodiments, which are presented for purposes of illustration rather than of limitation, and that the present invention is limited only by the claims that follow.

What is claimed is:

1. One or more computer-readable storage media having computer-readable program code embodied in or on the storage media, the code when executed by one or more processors for configuring a computer to execute a method for using a customizable spreadsheet application, the method for interfacing between the customizable spreadsheet application and a third party financial institution application, the method comprising:
providing an application programming interface (“API”) for use with the spreadsheet, the API that is configured to:
receive a Bank Administration Institute, version 2 (“BAI2”) file;
in response to receiving the BAI2 file, determine whether the identity of the third party financial institution associated with the financial institution application is recognized by the API;
in response to a determination that the identity of the third party financial institution is recognized by the API, then determine whether any customized codes associated with the third party financial institution exist in the BAI2 file;
in response to a determination that any customized codes associated with the third party financial institution exist in the BAI2 file, determine whether said customized codes have already been associated, by the API, with interpretations; and
in response to a determination that said customized codes have already been associated with interpretations, then parse the BAI2 file based on the interpretations.

2. The method of claim 1, wherein, the API is further configured to create a new third party institution file to store customized code interpretations of the customized codes thereto in response to determining that the identity of the third party financial institution is not recognized by the API.

3. The method of claim 2, wherein, the API is further configured to store customized code interpretations of the customized codes to the new third party institution file in response to determining that customized codes exist in said BAI2 file.

4. The method of claim 1, wherein, upon receipt of user instructions, and in response to determining that said customized codes have not already been associated, by the API, with interpretations, the API is further configured to associate said customized codes with interpretations.

5. The method of claim 1, wherein, when the API determines that either the customized codes are already interpreted or the API has received user instructions to associate the customized codes with interpretations, the API is further configured to provide a dialogue box for querying whether a user selects to confirm interpretation of customized codes with the third party institution.

6. The method of claim 5, wherein, when the API receives instructions to confirm interpretation of the customized codes with the third party institution, the API is configured to transmit the interpretations of the customized codes to the third party institution.

7. The method of claim 6, wherein, when the API transmits the interpretations of the customized codes to the third party institution, the API is further configured to receive confirmation of the interpretations of the customized codes from the third party institution.

8. The method of claim 7, wherein, upon receipt of the confirmation by the API interpretation of the customized codes, the API is further configured to parse the BAI2 file.

9. The method of claim 5, wherein when the API receives instructions to not confirm interpretation of the customized codes with the third party institution, the API is further configured to parse the BAI2 file.

10. An apparatus having a server, the apparatus for providing an interface between a customizable spreadsheet application and a third party financial institution Bank Administration Institute, version 2 (“BAI2”) file-generating application, the server comprising:
a server storage device;
a server processor connected to the server storage device, the server storage device storing a server program for controlling the server processor; and
the server processor operative with the server program to:
receive a BAI2 file from the file-generating institution;
in response to receiving the BAI2 file, determine whether the third party financial institution associated with the financial institution application is recognized by the server program;
in response to a determination that the third party financial institution is recognized by the server program, then determine whether any customized codes associated with third party financial institution exist in the BAI2 file;
in response to a determination that any customized codes associated with the third party financial institution exist in the BAI2 file, determine whether said customized codes have already been interpreted, by the server program; and
in response to a determination that said customized codes have already been interpreted, then parse the BAI2 file.

11. The apparatus of claim 10, wherein, the server processor is further operative with the server program to create a new third party institution file to attribute customized code interpretations of the customized codes thereto in response to a determination that the third party financial institution is not recognized by the server program.

12. The apparatus of claim 11, wherein, the server processor is further operative with the server program to prompt a user to interpret the customized codes in response to a determination that the customized codes exist in said BAI2 file.

13. The apparatus of claim 12, wherein, in response to receipt of user instructions relating to interpretation of the customized codes, then the server processor is further operative with the server program to attribute customized code interpretations to the new third party institution file.

14. The apparatus of claim 10, wherein, upon receipt of user instructions, when said customized codes have not already been associated, by the server program, with interpretations, then the server processor is further operative with the server program to associate said customized codes with interpretations.

15. The apparatus of claim 10, wherein, when the server program determines that either the customized codes are already interpreted or the server program has received user instructions to associate the customized codes with interpretations, then the server processor is further operative with the server program to provide a dialogue box for querying whether a user selects to confirm interpretation of the customized codes with the third party institution.

16. The apparatus of claim 15, wherein, when the server program receives instructions to confirm interpretation of the customized codes with the third party institution, the server program is further operative with the server program to transmit the interpretations of the customized codes to the third party institution.

17. The apparatus of claim 16, wherein, when the server program transmits the interpretations of the customized codes to the third party institution, the server processor is further operative with the server program to receive confirmation of the interpretations of the customized codes from the third party institution.

18. The apparatus of claim 17, wherein, upon receipt of the confirmation by the server program interpretation of the customized codes, the server processor is further operative with the server program to parse the BAI2 file.

19. The apparatus of claim 17, wherein when the server program receives instructions to not confirm interpretation of the customized codes with the third party institution, the server program is further operative with the server program to parse the BAI2 file.

20. One or more computer-readable storage media having computer-readable program code embodied in or on the storage media, the code when executed by one or more processors for configuring a computer to execute a method for using a customizable spreadsheet application, the method for interfacing between the customizable spreadsheet application and a third party financial institution application, the method comprising:
providing an application programming interface (“API”) for use with the spreadsheet, the API that is configured to:
receive a Bank Administration Institute, version 2 (“BAI2”) file;
in response to receiving the BAI2 file, query whether the identity of the third party financial institution associated with the financial institution application is recognized by the API;
in response to a determination that the identity of the third party financial institution is recognized by the API, then query whether any customized codes associated with third party financial institution exist in the BAI2 file;
in response to a determination that any customized codes associated with the third party financial institution exist in the BAI2 file, determine whether said customized codes have already been associated, by the API, with interpretations;
in response to a determination that said customized codes have already been associated with interpretations, then parse the BAI2 file based on the interpretations;
in response to a determination that said customized codes have not already been associated with interpretations; then prompt a user to provide a descriptor of each of the customized codes and identify whether each of the customized codes is a credit or debit transaction.

21. The method of claim 20 further comprising, when customized codes have not already been associated with interpretations, prompting a user to select a corresponding summary code for each of the customized codes.
